(19) United States
(12) Patent Application Publication
(10) Pub. No.: US 2014/0040153 A1
(43) Pub. Date: Feb. 6, 2014

(54) System and Method for Providing a Configurable Web Portal Builder Interfacing with a Customer Relationship Management System

(71) Applicant: CareDirector USA LLC, Reston, VA (US)

(72) Inventors: Tevinder Singh, Dublin (IE); Darragh Bourke, Dublin (IE); Tamilla Mamedova, Dublin (IE); Ibon San Vicente, Dublin (IE); Cormac Maher, Dublin (IE); Pat Mulhern, Dublin (IE)

(73) Assignee: CareDirector USA LLC, Reston, VA (US)

(21) Appl. No.: 13/960,072

(22) Filed: Aug. 6, 2013

Related U.S. Application Data
(60) Provisional application No. 61/680,251, filed on Aug. 6, 2012.

(51) Int. Cl. G06Q 50/26; G06Q 10/10

(52) U.S. Cl. CPC G06Q 50/26; G06Q 10/105
USPC 705/320

(57) ABSTRACT

A system and method for a web portal builder that is user-configurable, enables improved customization of a web portal, and provides a highly collaborative environment to various interested entities is described. The web portal builder may generate interfaces such as web portals that expose functionality and data of the backend Consumer Relationship Management (“CRM”) system as well as extend CRM functions and data capabilities. The web portal builder may build interfaces for use by entities such as governments, agencies of governments, businesses and others who deal with consumers. The entities may use the interfaces to view and manage consumers, leveraging information stored by or in association with the CRM system. For example, a government social services case manager may use the interfaces to manage information related to consumers (in this case, individuals applying for or receiving various social benefits).

### CROSS-REFERENCE TO RELATED APPLICATIONS

This application claims priority to U.S. Provisional Patent Application No. 61/680,251, filed Aug. 6, 2012, which is hereby incorporated by reference herein in its entirety.

### FIELD OF THE INVENTION

The invention relates to extending a Customer Relationship Management (“CRM”) system via a configurable web portal builder that builds web portals that can interface with the CRM system, enabling collaboration among various interested entities, and improving configuration management and customization of web portals.

### BACKGROUND OF THE INVENTION

Entities such as governments, agencies of governments, businesses and others who deal with consumers oftentimes have difficulty interfacing with and managing information related to their consumers. For example, the traditional human service and social care service management approach requires service personnel to develop a personalized service plan for each individual consumer (who, in this example, may include a resident seeking government services). From the perspective of the service provider, this approach places unnecessary burden on service personnel and increases costs for service providers because the service plans are often incomplete or inadequate to address the needs of consumers. On the other hand, from the perspective of consumers, this approach do not provide adequate access to communicate their service needs and to participate in the early stages of planning, particularly with respect to decisions about service plans, service delivery, and budgets. Although conventional CRM systems have been developed to attempt to organize the large amount of customer relationship data and improve understanding between an entity and its consumers, they typically fail to provide adequate interfaces and tools to assist the entity and the consumer. The lack of adequate tools creates a disconnect between entities and their consumers, which often leaves the entity with inefficient ways to communicate and receive information and consumers frustrated and dissatisfied.

Therefore, it is desirable to provide collaborative environment that support interactions between entities such as service providers and their consumers. Such a tool can help automate and streamline consumer management processes, resulting in productivity improvements, cost savings, and improved consumer satisfaction.

Techniques and platforms may be desirable that provide the capability to build a collaborative web portal that can be easily configurable and customizable to meet evolving needs of service consumers. These and other problems exist.

### SUMMARY OF THE INVENTION

The invention addressing these and other drawbacks relates to a system and method for a web portal builder that is user-configurable, enables improved customization of a web portal, and provides a highly collaborative environment to various interested entities.

Included in this system and method are a Customer Relationship Management (CRM) system and a web portal builder. Generally speaking, the web portal builder may build interfaces such as portals that expose functionality and data of the backend CRM system as well as extend CRM functions and data capabilities.

In some implementations, the web portal builder may build a provider-facing portal (also referred to herein as “interface” or “web portal”) that is configured to provide an interface for entities such as governments, agencies of governments, businesses and others who deal with consumers (hereinafter also referred to as “providers”). The providers may use the provider-facing portal to view and manage consumers, leveraging information stored by or in association with the CRM system. For example, a government social services case manager may use the provider-facing portal to manage consumers (in this case, individuals applying for or receiving various social benefits).

In some implementations, the web portal builder may build a consumer-facing portal that is configured to provide an interface for consumers such as individuals who receive products and/or services from providers. For example, the consumers may use the consumer-facing portal to apply for benefits, view and manage existing benefits, receive updates on the status of benefits, and/or otherwise interface with the provider.

The CRM system is configured to manage and store configuration data that specifies information related to the entity. The configuration data may be predefined by the CRM system and/or determined by user input. The web portal builder may be configured to receive and/or extend the configuration data from the CRM system and generate one or more web portals based on the configuration data. In addition, the web portal builder can further enhance the CRM capabilities to create custom industry solutions. The web portal builder may customize content of a web portal, localize the portal based on a target locality, customize user accounts and security roles, build custom forms, and/or customize rules and policies associated with the portal.

The web portal builder may be further configured to replicate a web portal to create a plurality of replicated web portals that are built based on configuration data that is commonly shared among the web portal and replicated web portals. The web portal builder may be further configured to customize at least one of the replicated web portals to target a specific group of users, organization, and/or geographical location and to store the customization data in a data store. The replicated web portals may be tailored to modify (e.g., add, delete, and/or change) configuration data to suit particular needs of a replicated web portal. For example, using the web portal builder, a state government staff can create multiple replicated web portals for different counties in the state. A replicated web portal may be tailored to an individual county's specifications such that it displays the county's flag, logo, color, and/or other characteristics associated with the county. Accordingly, a single installation of a web portal builder at the state-level facility may support multiple counties and their different needs.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates high-level system architecture for a user-configurable web portal builder, according to an aspect of the invention.

FIG. 2 illustrates a system for a user-configurable web portal builder, according to an aspect of the invention.

FIG. 3 illustrates a process for customizing a web portal using a user-configurable web portal builder, according to an aspect of the invention.

FIG. 4 illustrates a graphical user interface for customizing header navigation links, according to an embodiment of the invention.

FIG. 5(a) illustrates a graphical user interface for customizing user security roles, according to an embodiment of the invention.

FIG. 5(b) illustrates a graphical user interface for customizing security permissions associated with a particular user security role, according to an embodiment of the invention.

FIG. 5(c) illustrates a graphical user interface for managing user accounts, according to an embodiment of the invention.

FIG. 6 illustrates a graphical user interface for localizing an error message to a different language, according to an embodiment of the invention.

FIG. 7 illustrates a graphical user interface for localizing Frequently Asked Questions (FAQ's) to a different language, according to an embodiment of the invention.

FIG. 8(a) illustrates a graphical user interface for creating one or more custom forms, according to an embodiment of the invention.

FIG. 8(b) illustrates an exemplary custom form created by form builder engine 124, according to an embodiment of the invention.

FIG. 9 illustrates a graphical user interface for managing and/or customizing site markers for a particular web portal, according to an embodiment of the invention.

### DETAILED DESCRIPTION OF THE INVENTION

The invention described herein is directed to a system and method for a web portal builder that is configurable, enables improved customization of a web portal, and provides a highly collaborative environment to various interested entities.

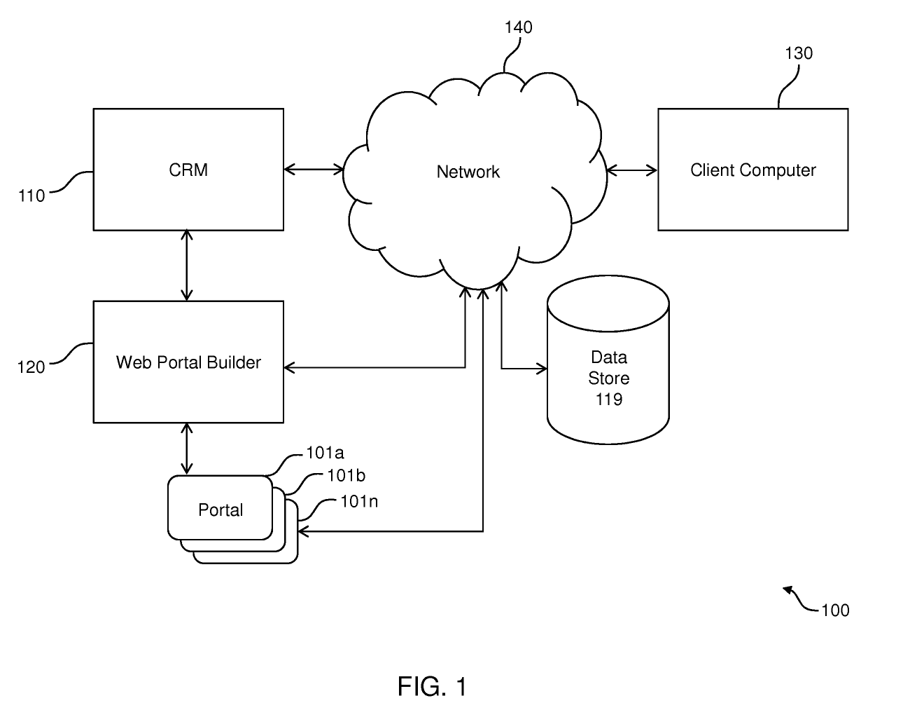

FIG. 1 illustrates a system 100 for a configurable web portal builder, according to an aspect of the invention. Generally speaking, system 100 may facilitate configuration management and improved customization of a web portal.

Client computer 130 may include a desktop computer, a laptop, a cell phone, a smart phone, a Personal Digital Assistant, a pocket PC, or other device that a user may use to communicate with web portal builder 120. For example, client computer 130 may communicate with web portal builder 120 via various communication channels such as electronic mail, voice call, Short Message Service (“SMS”) text messaging, the Internet (e.g., via a web page), social networks, etc.

CRM 110 may be configured to manage and store data associated with content, user management, localization, forms, rules and policy, etc. The data may be collectively referred to as “configuration data” (used interchangeably with “configuration information”). The configuration data may be predefined by CRM 110 and/or determined by user input. CRM 110 may provide the configuration data to web portal builder 120, which extends the configuration data to create and tailor portal functionality.

Web portal builder 120 may comprise one or more computing devices configured to perform the various features and functions of the invention, as described in greater detail below. For example, web portal builder 120 may be configured to receive the configuration data from CRM 110 and generate one or more web portals 101 (illustrated in FIG. 1 as portal 101a, 101b, . . . , 101n) based on the configuration data. Web portal 101 can include a provider-facing portal or a consumer-facing portal.

The provider-facing portal may be configured to provide an interface for providers. The providers may use the provider-facing portal to view and manage consumers, leveraging information stored by or in association with the CRM system. For example, a government social services case manager may use the provider-facing portal to manage consumers (in this case, individuals applying for or receiving various social benefits).

The consumer-facing portal may be configured to provide an interface for consumers. For example, the consumers may use the consumer-facing portal to apply for benefits, view and manage existing benefits, receive updates on the status of benefits, and/or otherwise interface with the provider.

A web portal 101 can be replicated (e.g., copied) to create a plurality of replicated web portals 101. In one embodiment, a portal developer (e.g., an individual that uses portal builder 120 to build portals) can customize at least one of the replicated web portals to target a specific group of users, organization, and/or geographical location. The portal developer may customize a replicated web portal by updating the replicated configuration data such as by modifying the replicated configuration data, adding new configuration data, and/or removing configuration data. For example, via web portal builder 120, a state government staff can create multiple replicated web portals for different counties in the state. A replicated web portal may be tailored to an individual county's specifications such that it displays the county's flag, logo, color, and/or other characteristics associated with the county. Accordingly, a single installation of web portal builder 120 at the state-level facility may support multiple counties and their different needs.

Those having skill in the art will recognize that web portal builder 120 may comprise a processor, one or more interfaces (to various peripheral devices or components), memory, one or more storage devices, and/or other components coupled via a bus. The memory may comprise random access memory (RAM), read only memory (ROM), or other memory. The memory may store computer-executable instructions to be executed by the processor as well as data that may be manipulated by the processor. The storage devices may comprise floppy disks, hard disks, optical disks, tapes, or other storage devices for storing computer-executable instructions and/or data.

One or more applications may be loaded into memory and run on an operating system of web portal builder 120. In one implementation, web portal builder 120 may comprise a server device, a desktop computer, a laptop, a cell phone, a smart phone, a Personal Digital Assistant, a pocket PC, or other device.

Web portal builder 120 may include or otherwise access one or more databases. In some implementations, web portal builder 120 may obtain contents, user roles information, customization settings, various forms, rules, and/or other information from data store 119.

Data store 119 may exist locally in web portal builder 120 and/or any other external storage device. In one embodiment, at least a portion of data store 119 may reside within CRM 110. Configuration data created or modified in web portal builder 120 that is not original to the CRM data structure can be stored in CRM 110 by formatting the configuration data to comply with CRM 110. For example, formatting may include converting (e.g., re-labeling) metadata of the new and/or modified configuration data.

Network 140 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), or other network.

The foregoing description of the various components comprising system architecture 100 is exemplary only, and should not be viewed as limiting. The invention described herein may work with various system configurations. Accordingly, more or less of the aforementioned system components may be used and/or combined in various implementations.

Having provided a non-limiting overview of exemplary system architecture 100, the various features and functions enabled by web portal builder 120 will now be explained.

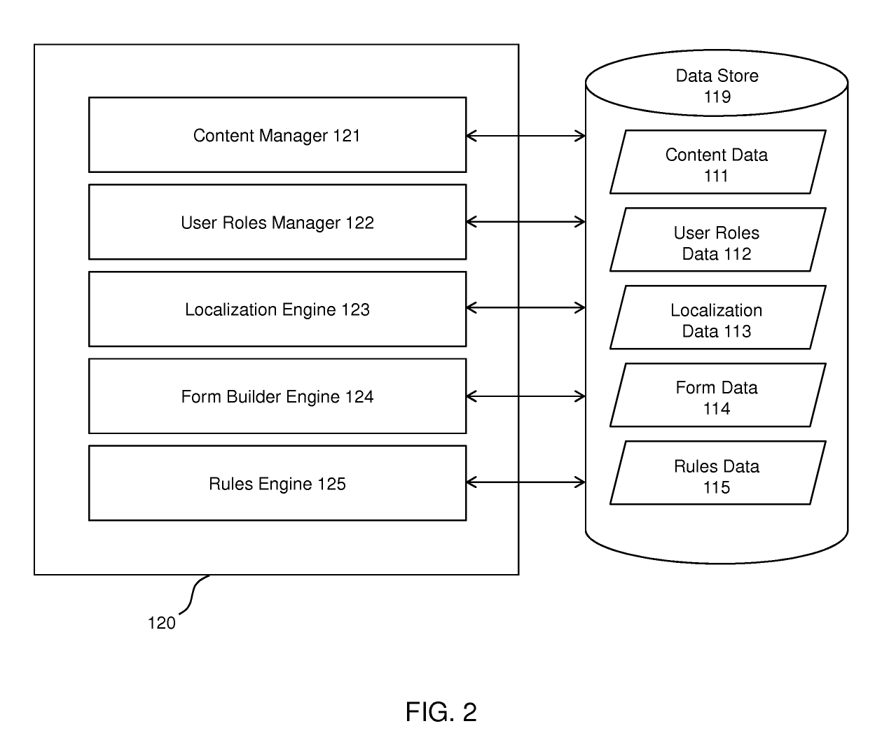

Referring to FIG. 2, web portal builder 120 may include content manager 121, user roles manager 122, localization engine 123, form builder engine 124, and rules engine 125. Content manager 121 may manage information presented on the web portal 101. The information may include, for example, content common to multiple pages including page headers and footers and/or other content elements such as links, text, graphics, media, and so on. New or modified content data can be stored in data store 119. A portal developer may add and/or remove header navigation links and publish the changes globally. In other words, the changes can be applied to one or more replicated web portals. Alternatively, the changes may be applied locally to a particular web portal that is selected by the portal developer. For example, if web portal 101a has been replicated to produce other replicated web portals 101b, . . . , 101n, a portal developer may customize header navigation links only in the replicated version 101b without modifying the other replicated versions. A user may browse a list of available web portals (e.g., one or more replicated web portals) and select a particular website from the list.

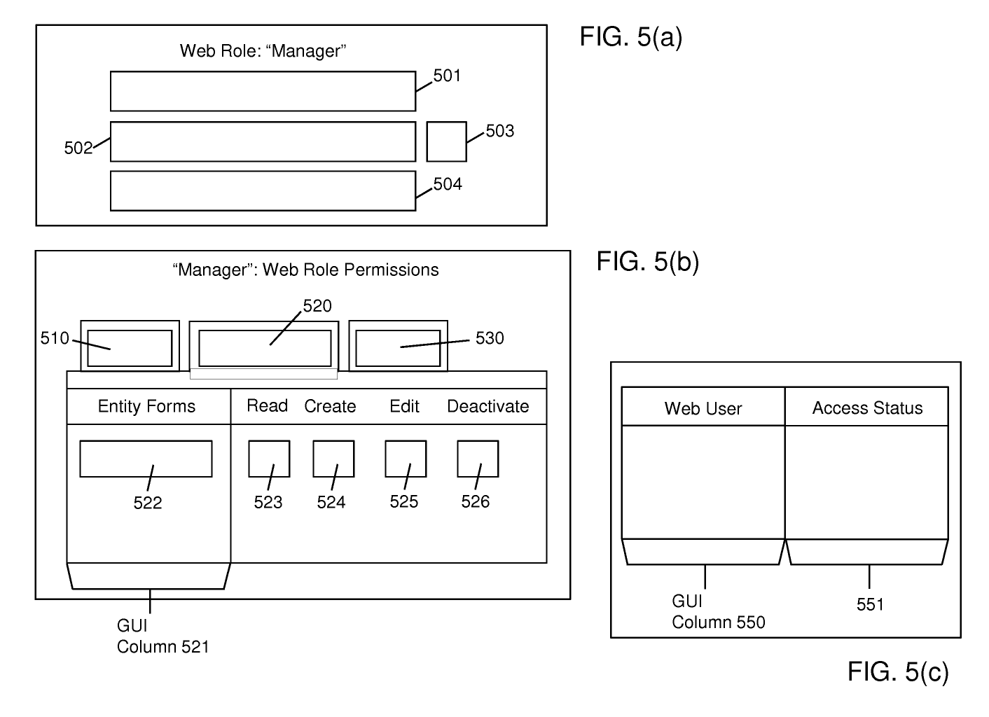

User roles manager 122 can provide role-based access control that is easily configurable by a user. A user may create user accounts and assign different security roles associated with the user accounts. Addition or modification made using user roles manager 122 can be published globally to one or more replicated web portals or locally by identifying a particular one of the replicated web portals. User roles manager 122 may assign a role with one or more security permissions. For example, a user assigned with the role, “Manager,” may be configured to be able to “read” and “create” but not “edit” a particular entity form. In addition, the user's access to a selected entity form can be deactivated by user roles manager 122. User roles manager 122 may facilitate management of user accounts by allowing a user to create, add, modify, and/or remove user accounts and to grant or deny access to a web portal. When access is requested for a particular web user, user roles manager 122 may display the approval status information, as illustrated in, for example, FIG. 5(c).

Localization engine 123 may be configured to localize configuration data stored in data store 119. By using localization engine 123, a user may customize a particular web portal by adapting the configuration data to different languages, regional differences, and/or other requirements of a target locality. For instance, localization may include translating content data into different languages, adding locale-specific components, altering format, and/or altering wording of content data to be displayed. For example, a general error message may be localized to display a different message tailored to a particular web portal. The localized data may be stored in data store 119 in association with the particular web portal. A user can browse a list of available web portals (e.g., one or more replicated web portals) and select a particular website from the list. The general error message to be displayed on the selected website may be “Your account is locked. Please contact the administrator,” but the user may localize it to provide the message in a different language. In another example, localization engine 123 may create, update, and/or publish Frequently Asked Questions (FAQ) in multiple different languages. Localization data can be applied locally to a particular web portal or globally to one or more replicated web portals.

Form builder engine 124 may be configured to create, update, and/or publish custom forms that may be used to capture data from various users such as service providers and consumers. An entity form associated with one or more custom forms may include one or more entity attributes which represent fields in a custom form. For example, an entity form named “ProviderDetail” may include entity attributes including Name, Type, FEIN, Legal Status, Preferred Name, IRS Status, Year of Incorporation, and so on. Entity forms and/or associated entity attributes may be created by and imported from CRM 110 to web portal builder 120. Entity forms and/or associated entity attributes may also be added, removed, and/or modified in web portal builder 120. The custom forms can be printed and/or electronically published to various users via web portal 101. If published as an electronic form, the recipients of the custom form may enter requested information into the form and return it to the requesting party via web portal 101. Any part of custom forms may be pre-populated automatically by form builder engine 124 and/or manually by user input. For example, form builder engine 124 may enter information into one or more fields in a custom form and store the custom form that is pre-populated with the information in data store 119. Form builder engine 124 may retrieve the pre-populated custom form from data store 119 to update the pre-populated custom form and/or publish it via web portal 101. Custom forms created and/or updated by form builder engine 124 may be re-usable. For example, instead of creating a new form, a user may import one of the existing custom forms stored in data store 119. The user may also modify entity attributes of the imported form to create another version and store the updated version in data store 119.

Rules engine 125 may be configured to manage and/or customize rules and policies associated with web portal builder 120. The rules and policies may be automatically determined by rules engine 125 and/or by user input. The rules and policies may include industry-specific rules. Program eligibility rules and/or resource allocation rules are one of many types of specific rules that can be implemented by rules engine 125. For example, program eligibility rules may determine preliminary eligibility of a service consumer to participate in programs provided by a service provider based on one or more eligibility criteria. A service provider may be a welfare provider and/or officers who work for the welfare provider. A service consumer may be a welfare recipient using web portal 101 to apply for welfare benefits. Rules engine 125 may create and/or update eligibility criteria associated with a particular program. In another example, resource allocation rules may determine allocation of resources such as budget, personnel, etc. based on service programs, providers, consumers, and/or other requirements.

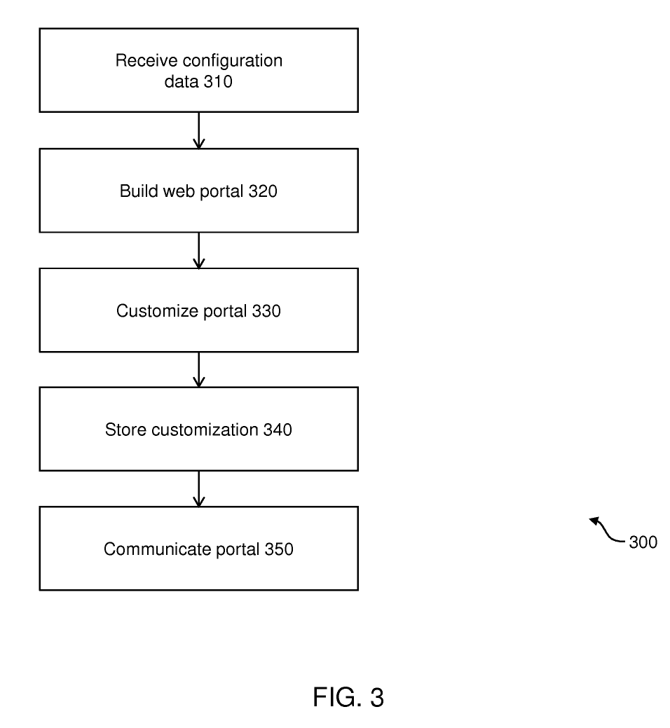

FIG. 3 illustrates a process 300 for customizing a web portal, according to an aspect of the invention. The various processing operations and/or data flows depicted in FIG. 3 (and in the other drawing figures) are described in greater detail herein. The described operations may be accomplished using some or all of the system components described in detail above and, in some embodiments, various operations may be performed in different sequences. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In operation 310, process 300 may receive configuration data from one or more sources. Such sources could include CRM 110 and/or web portal builder 120 itself. The configuration data may be used to create and tailor portal functionality.

In operation 320, process 300 may build one or more web portals based on the configuration data. In one embodiment, process 300 in operation 320 may include replicating (e.g., copying) a web portal to create a plurality of replicated web portals. In one embodiment, a portal developer can customize at least one of the replicated web portals to target a specific group of users, organization, and/or geographical location.

In operation 330, process 300 may customize one or more web portals by creating and/or updating configuration data stored in data store 119. The process may customize content including page headers and footers and/or other content elements such as links, text, graphics, media, and so on. The process may provide role-based access control that is easily configurable by a user. The process may create user accounts and assign different security roles associated with the user accounts. A role may be assigned with one or more security permissions. For example, the process may grant a user assigned with the role, “Manager,” to “read” and “create” but not “edit” a particular entity form. In addition, the process may facilitate management of user accounts by creating, adding, modifying, and/or removing user accounts and by granting or denying access to a web portal. The process may localize configuration data stored in data store 119. The process may customize a particular web portal by adapting the configuration data to different languages, regional differences, and/or other requirements of a target locality. For example, localization may include translating content data into different languages, adding locale-specific components, altering format, and/or altering wording of content data to be displayed. The process may create and/or custom forms that may be used to capture data from various users such as service providers and consumers. An entity form associated with one or more custom forms may include one or more entity attributes which represent fields in a custom form. For example, an entity form named “ProviderDetail” may include entity attributes including Name, Type, FEIN, Legal Status, Preferred Name, IRS Status, Year of Incorporation, and so on. The process may manage and/or customize rules and policies associated with a web portal. The rules and policies may include industry-specific rules such as program eligibility rules and/or resource allocation rules. For example, program eligibility rules may determine preliminary eligibility of a service consumer to participate in programs provided by a service provider based on one or more eligibility criteria. The process may create and/or update eligibility criteria associated with a particular program. In another example, resource allocation rules may determine allocation of resources such as budget, personnel, etc. based on service programs, providers, consumers, and/or other requirements. In one embodiment, the process may customize a replicated web portal by updating the replicated configuration data such as by modifying the replicated configuration data, adding new configuration data, and/or removing configuration data. Customization may be published globally to one or more replicated web portals or locally by identifying a particular one of the replicated web portals.

In operation 340, process 300 may store changes associated with the process in operation 330 in data store 119. Data store 119 may exist locally in web portal builder 120 and/or any other external storage device. In one embodiment, data store 119 or a part of it may reside within CRM 110. Configuration data created or modified in the process in operation 330 that is not original to the CRM data structure can be stored in CRM 110 by formatting the configuration data to comply with CRM 110. For example, formatting may include converting (e.g., re-labeling) metadata of the new and/or modified configuration data.

In operation 350, process 300 may communicate the one or more web portals built and/or replicated to be displayed at, for example, client computer 130.

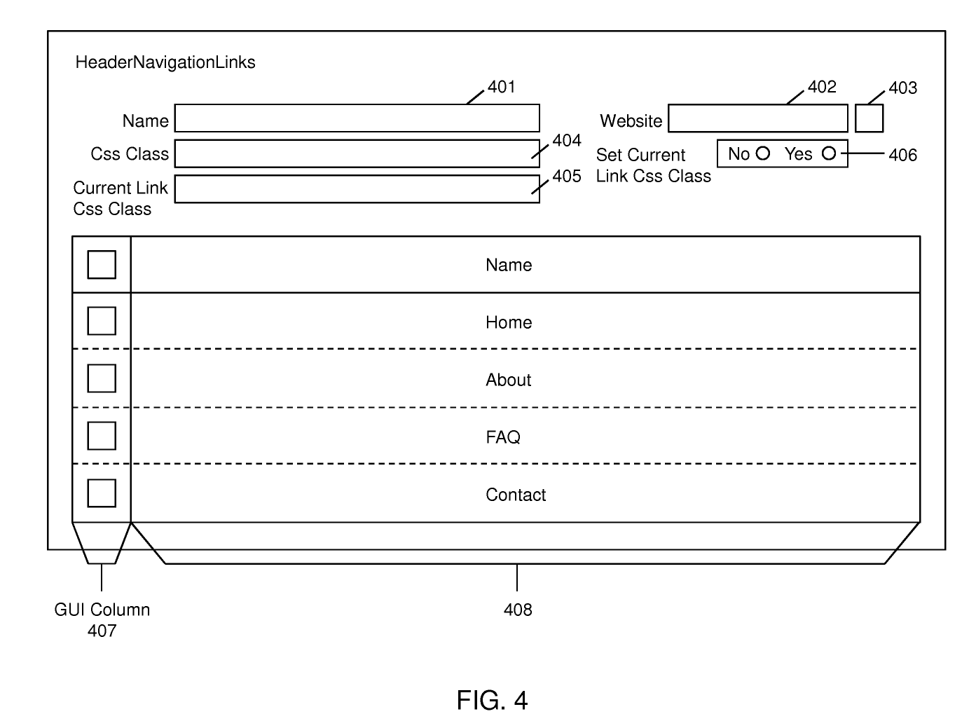

FIGS. 4-9 illustrate screenshots of a web portal interface generated by web portal builder 120, according to an implementation of the invention. The screenshots are for illustrative purposes only. Various components may be added, deleted, moved, or otherwise changed so that the configuration, appearance, and/or content of the screenshots may be different than as illustrated in the figures. Accordingly, the graphical user interface objects as illustrated (and described in greater detail below) are exemplary by nature and, as such, should not be viewed as limiting. Various inputs may include text inputs, radio selection inputs, checkboxes, dropdown boxes, and/or other input elements.

FIG. 4 illustrates a graphical user interface for customizing header navigation links, according to an embodiment of the invention. GUI object 401 may include a text input for a name for a particular head navigation link set. Header navigation links included in the header navigation link set may appear in the page headers. GUI object 402 may include an input for a particular web portal to which the header navigation link set applies. GUI object 403 may include a clickable icon used to browse a list of available web portals (e.g., one or more replicated web portals) and select a particular web portal. GUI object 404 may include an input for Css class. GUI object 405 may include an input for current link Css class and GUI object 406 may include a radio selection input for setting current link Css class. GUI column 407 may include checkboxes for adding, removing, and/or modifying a particular header navigation link. GUI column 408 may include names of header links (e.g., home, about, FAQ, contact, etc.) as they should appear in the page headers.

FIG. 5(a) illustrates a graphical user interface for customizing user security roles, according to an embodiment of the invention. GUI object 501 may include an input for a particular user role such as “Manager.” GUI object 502 may include an input for a particular web portal to which the security roles and associated security permissions apply. GUI object 503 may include a clickable icon used to browse a list of available web portals (e.g., one or more replicated web portals) and select a particular web portal. GUI object 504 may include a text input for describing the role specified in GUI object 501.

FIG. 5(b) illustrates a graphical user interface for customizing security permissions associated with a particular user security role, according to an embodiment of the invention. GUI object 510 may include a page tab for “web pages.” GUI object 520 may include a page tab for “entity forms.” GUI object 530 may include a page tab for “tasks.” In the page tab for “entity forms,” GUI column 521 may include a list of entity forms. GUI object 522 may display a particular entity form. GUI object 523 may include a checkbox for permission to “read” the entity form described in GUI object 522. GUI object 524 may include a checkbox for permission to “create” the entity form described in GUI object 522. GUI object 525 may include a checkbox for permission to “edit” the entity form described in GUI object 522. GUI object 526 may include a checkbox for deactivating the entity form described in GUI object 522.

FIG. 5(c) illustrates a graphical user interface for managing user accounts, according to an embodiment of the invention. GUI column 550 may include a list of web users associated with a particular web portal. GUI column 551 may include information about access status associated with a particular web user. For example, the access status may include “Waiting for Approval” and/or “Approved.”

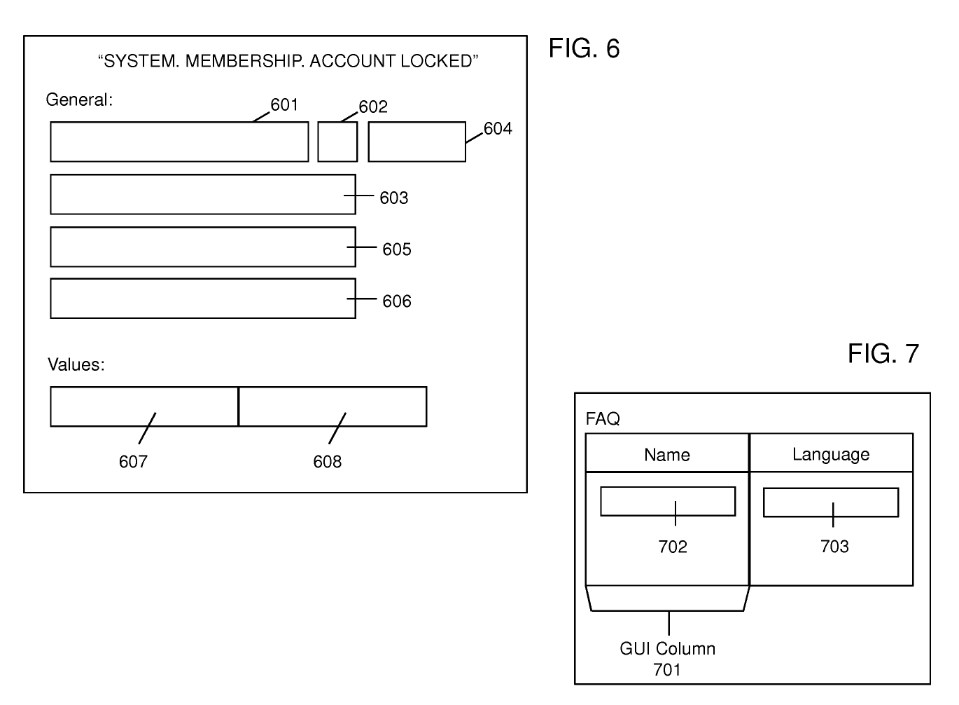

FIG. 6 illustrates a graphical user interface for localizing an error message to a different language, according to an embodiment of the invention. GUI object 601 may include an input for a particular web portal to which the localized error message applies. GUI object 602 may include a clickable icon used to browse a list of available web portals (e.g., one or more replicated web portals) and select a particular web portal. GUI object 603 may include an input for a name of the error message (e.g., “System.Membership.AccountLocked”). GUI object 604 may include an input for an identification of the owner for the error message. GUI object 605 may include a dropdown box for string type. GUI object 606 may include a text input for describing the error message. GUI object 607 may include an input for language type in which the error message should be displayed. For example, GUI object 607 may indicate “Base” where the base language may be English. GUI object 608 may include an input for a text string that is displayed for the error message. For example, GUI object 608 may indicate “Your account is locked. Please contact the administrator.”

FIG. 7 illustrates a graphical user interface for localizing Frequently Asked Questions (FAQ's) to a different language, according to an embodiment of the invention. GUI column 701 may include a list of FAQ's to be displayed on a particular web portal. GUI object 702 may include an input for a name for a particular FAQ. For example, GUI object 702 may include “What do I do if I forget my password?”. GUI object 703 may include an input for language type in which a particular FAQ should be displayed.

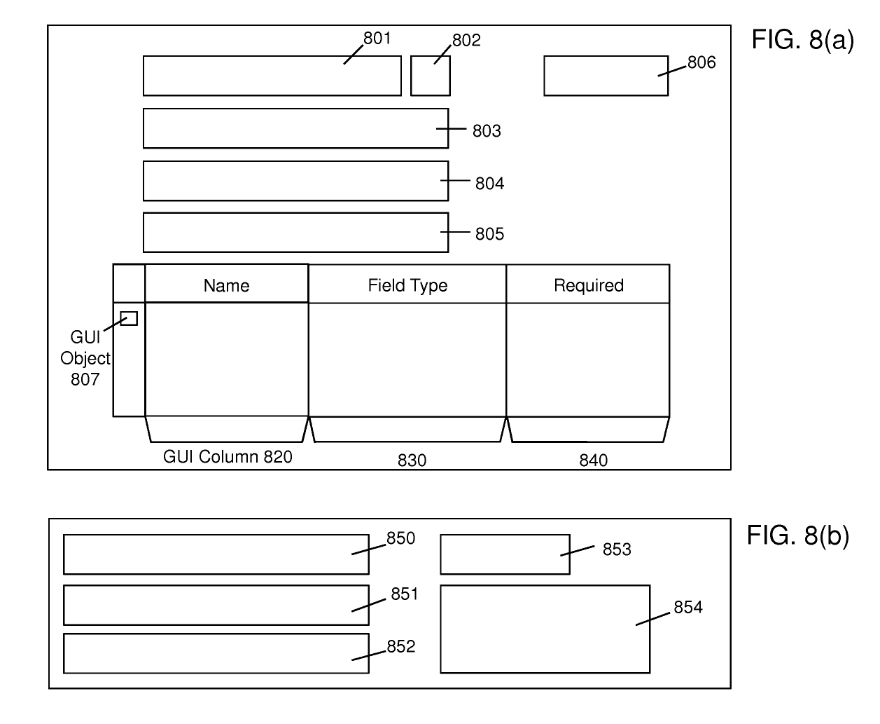

FIG. 8(a) illustrates a graphical user interface for creating one or more custom forms, according to an embodiment of the invention. GUI object 801 may include an input for a particular entity form. GUI object 802 may include a clickable icon used to browse a list of available entity forms and select a particular entity form. GUI 803 may include an input for a name for a particular custom form. GUI object 804 may include an input for the label of the custom form. GUI object 805 may include a dropdown box for a form layout. GUI object 806 may include an input for an identification of the owner for the custom form. GUI column 820 may include a list of names for entity attributes (e.g., Name, Type, FEIN, Year of Incorporation, Description, etc.). GUI object 807 may include a checkbox for adding, removing, and/or modifying a particular entity attribute. GUI column 830 may include field types for entity attributes. GUI column 840 may include information indicating whether a particular entity attribute is a required field for the custom form.

FIG. 8(b) illustrates an exemplary custom form created by form builder engine 124, according to an embodiment of the invention. GUI object 850 may include an input for the name of an organization. GUI object 851 may include a dropdown box for the type of the organization. GUI object 852 may include an input for FEIN, and GUI object 853 may include an input for the year of incorporation for the organization. GUI object 854 may include an input for description.

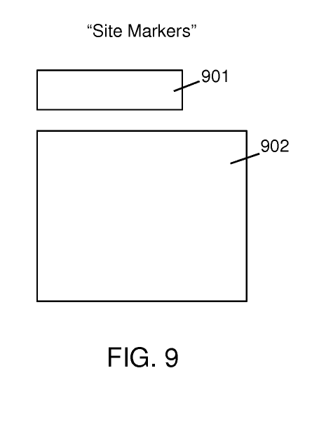

FIG. 9 illustrates a graphical user interface for managing and/or customizing site markers for a particular web portal, according to an embodiment of the invention. GUI object 901 may include an identification of a particular web portal. GUI object 902 may include a list of site markers such as “Home Page,” “About Us,” “Account Setting,” “Change Password,” etc.

Implementations of the invention may be made in hardware, firmware, software, or any suitable combination thereof. Implementations of the invention may also be implemented as instructions stored on a machine readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description. As such, the specification and drawings should be regarded as exemplary only, and the scope of the invention to be determined solely by the appended claims.

1. A computer-implemented method of facilitating the provision of government social benefits based on information from Customer Relationship Management (CRM) systems, the method being implemented on a computing system programmed with one or more computer program instructions, the method comprising:
receiving, by the computing system, configuration information from a CRM system, wherein the configuration information is associated with a social benefits provider;
receiving, by the computing system, first customization information that includes a customization to the configuration information;
generating, by the computing system, a social benefits interface based on the configuration information and the first customization information; and
communicating, by the computing system, the social benefits interface.

2. The method of claim 1, the method further comprising:
associating, by the computing system, the social benefits interface with a locale; and
localizing, by the computing system, at least a portion of the social benefits interface based on the locale.

3. The method of claim 2, wherein localizing at least a portion of the social benefits interface comprises localizing at least a portion of the configuration information based on the locale such that the portion or all of the social benefits interface is localized.

4. The method of claim 1, the method further comprising:
replicating, by the computing system, the social benefits interface to generate at least a first replicated social benefits interface such that the social benefits interface and the first replicated social benefits interface are generated based on the configuration information and the first customization information.

5. The method of claim 4, the method further comprising:
receiving, by the computing system, second customization information that customizes the first replicated social benefits interface but not the social benefits interface, wherein the first replicated social benefits interface is generated based further on the second customization information.

6. The method of claim 1, the method further comprising:
replicating, by the computing system, the social benefits interface to generate a plurality of replicated social benefits interfaces such that the social benefits interface and the plurality of replicated social benefits interfaces are generated based on the configuration information and the first customization information; and
receiving, by the computing system, second customization information, wherein each of the plurality of replicated social benefits interfaces is generated based on the second customization information.

7. The method of claim 1, the method further comprising:
replicating, by the computing system, the social benefits interface to generate a plurality of replicated social benefits interfaces such that the social benefits interface and the plurality of replicated social benefits interfaces are generated based on the configuration information and the first customization information; and
receiving, by the computing system, second customization information, wherein only a subset of the plurality of replicated social benefits interfaces is generated based on the second customization information.

8. The method of claim 1, the method further comprising:
receiving, by the computing system, an eligibility rule; and
determining, by the computing system, whether a social benefit applicant is eligible to receive the social benefit based on the eligibility rule.

9. The method of claim 8, wherein the social benefits interface comprises a customer-facing interface, the method further comprising:
receiving, by the computing system, social benefit application information; and
comparing, by the computing system, at least a portion of the social benefit application information with at least a portion of the eligibility rule, wherein the determination of whether the social benefit applicant is eligible to receive the social benefit is based further on the comparing.

10. The method of claim 9, the method further comprising:
formatting, by the computing system, the social benefit application information into a format used by the CRM; and
causing, by the computing system, the formatted social benefit application information to be stored by the CRM.

11. The method of claim 1, the method further comprising:
causing, by the computing system, the customization information to be stored by the CRM; and
generating, by the computing system, a third social benefit interface based on the stored customization information.

12. A system that facilitates the provision of government social benefits based on information from Customer Relationship Management (CRM) systems, the computing system comprising:
a computing system programmed with one or more computer program instructions, the computing system programmed to:
receive configuration information from a CRM system, wherein the configuration information is associated with a social benefits provider;
receive first customization information that includes a customization to the configuration information;
generate a social benefits interface based on the configuration information and the first customization information; and
communicate the social benefits interface.

13. The system of claim 12, wherein the computing system is further programmed to:
associate the social benefits interface with a locale; and
localize at least a portion of the social benefits interface based on the locale.

14. The system of claim 13, at least a portion of the configuration information is localized based on the locale such that the portion or all of the social benefits interface is localized.

15. The system of claim 12, wherein the computing system is further programmed to:
replicate the social benefits interface to generate at least a first replicated social benefits interface such that the social benefits interface and the first replicated social benefits interface are generated based on the configuration information and the first customization information.

16. The system of claim 15, wherein the computing system is further programmed to:
receive second customization information that customizes the first replicated social benefits interface but not the social benefits interface, wherein the first replicated social benefits interface is generated based further on the second customization information.

17. The system of claim 12, wherein the computing system is further programmed to:
replicate the social benefits interface to generate a plurality of replicated social benefits interfaces such that the social benefits interface and the plurality of replicated social benefits interfaces are generated based on the configuration information and the first customization information; and
receive second customization information, wherein each of the plurality of replicated social benefits interfaces is generated based on the second customization information.

18. The system of claim 12, wherein the computing system is further programmed to:
replicate the social benefits interface to generate a plurality of replicated social benefits interfaces such that the social benefits interface and the plurality of replicated social benefits interfaces are generated based on the configuration information and the first customization information; and
receive second customization information, wherein only a subset of the plurality of replicated social benefits interfaces is generated based on the second customization information.

19. The system of claim 12, wherein the computing system is further programmed to:
receive an eligibility rule; and
determine whether a social benefit applicant is eligible to receive the social benefit based on the eligibility rule.

20. The system of claim 19, wherein the social benefits interface comprises a customer-facing interface, and wherein the computing system is further programmed to:
receive social benefit application information; and
compare at least a portion of the social benefit application information with at least a portion of the eligibility rule, wherein the determination of whether the social benefit applicant is eligible to receive the social benefit is based further on the comparing.

21. The system of claim 20, wherein the computing system is further programmed to:
format the social benefit application information into a format used by the CRM; and
cause the formatted social benefit application information to be stored by the CRM.

22. The system of claim 12, wherein the computing system is further programmed to:
cause the customization information to be stored by the CRM; and
generate a third social benefit interface based on the stored customization information.

23. A computer-implemented method of generating interfaces based on information from Customer Relationship Management (CRM) systems, the method being implemented on a computing system programmed with one or more computer program instructions, the method comprising:
receiving, by the computing system, configuration information from a CRM system;
receiving, by the computing system, first customization information that includes a customization to the configuration information;
generating, by the computing system, an interface based on the configuration information and the first customization information; and
communicating, by the computing system, the interface.
